(19) United States
(12) Patent Application Publication
(10) Pub. No.: US 2026/0183761 A1
(43) Pub. Date: Jul. 2, 2026

(54) Membranes

(71) Applicants: Fujifilm Manufacturing Europe B.V., Tilburg (NL); Fujifilm Corporation, Tokyo (JP)

(72) Inventors: Jacko Hessing, Tilburg (NL); Elisa Huerta Martinez, Tilburg (NL)

(21) Appl. No.: 19/125,572

(22) PCT Filed: Dec. 5, 2023
(86) PCT No.: PCT/EP2023/084311

§ 371 Date: Apr. 29, 2025

(30) Foreign Application Priority Data
Dec. 22, 2022 (NL) 2033795

(51) Int. Cl. B01J 47/12; B01D 61/42; B01D 61/44; B01D 71/62; B01J 41/04; B01J 41/14; C08F 12/34; C08J 5/22; C25B 13/08; H01M 8/103; H01M 8/18

(52) U.S. Cl. CPC B01J 47/12; B01D 61/422; B01D 61/445; B01D 71/62; B01J 41/04; B01J 41/14; C08F 12/34; C08J 5/2231; C25B 13/08; H01M 8/103; H01M 8/188; C08J 2325/18

(57) ABSTRACT

An anion exchange membrane obtainable by curing a curable composition comprising a component (a) comprising: a compound (A) and/or a compound (B) and/or a compound (C); wherein: (A) is an optionally substituted non-aromatic bicyclic structure comprising two nitrogen atoms, wherein the rings of said non-aromatic bicyclic structure are independently 4-, 5- 6- or 7-membered; wherein each of said rings comprises a nitrogen atom which may be at a bridgehead position; wherein to each of said nitrogen atoms are attached one or two groups independently selected from hydrogen, C₁₋₃ alkyl, C₅₋₆ cycloalkyl, and vinylbenzyl, provided that the compound comprises at least two vinylbenzyl groups; (B) is an optionally substituted 5- 6- or 7-membered non-aromatic heterocyclic ring comprising one nitrogen atom and as substituent to the ring a C₁₋₆ alkyl group comprising a nitrogen atom; wherein to the nitrogen atom of said non-aromatic heterocyclic ring are attached one or two groups independently selected from hydrogen, C₁₋₃ alkyl, C₅₋₆ cycloalkyl, and vinylbenzyl, provided that the compound comprises at least two vinylbenzyl groups; (C) is an optionally substituted non-aromatic spirocyclic structure comprising two nitrogen atoms, wherein the rings of said non-aromatic spirocyclic structure are independently 4- 5- or 6-membered; wherein each of said rings comprises at least one nitrogen atom which may be at a bridgehead position; wherein to each of said nitrogen atoms are attached one or two groups independently selected from hydrogen, C₁₋₃ alkyl, C₅₋₆ cycloalkyl, and vinylbenzyl, provided that the compound comprises at least two vinylbenzyl groups.

This invention relates to ion exchange membranes, especially anion exchange membranes (AEMs), their preparation processes and their use.

Ion exchange membranes are used in electrodialysis, electrolysis, production of acids and bases and a number of other processes. Typically the transport of ions through the membranes occurs under the influence of a driving force such as an electrical potential gradient.

Some ion exchange membranes comprise a porous support, which provides mechanical strength. Such membranes are often called “composite membranes” due to the presence of both an ionically charged polymer which discriminates between oppositely charged ions and the porous support which provides mechanical strength.

For generation of acids and bases generally BPMs are used, e.g. in a process called bipolar electrodialysis (BPED). A BPM has both a cationic layer or anion exchange layer (AEL) and an anionic layer or cation exchange layer (CEL) and thus has both a negatively charged layer and a positively charged layer.

In the BPED process acid and base are generated at the interface of a BPM by means of a water dissociation reaction (WDR). The H⁺ and OH⁻ ions generated travel across the corresponding ion exchange layers towards the cathode and the anode respectively. The BPED process is performed in a bipolar electrodialysis stack comprising additional to bipolar membranes monopolar anion exchange and monopolar cation exchange membranes. In the bipolar electrodialysis stack, the monopolar cation and anion exchange membranes take care of selectively separating the salt ions of the feed stream by their charge. The salt anion will then combine with the H+ formed during the WDR to form an acid and the salt cation will combine with the OH- to form a base. For example, if NaCl is used in the feed stream, the monopolar membranes will separate Na⁺ from Cl⁻ whereby NaOH and HCl are formed.

For generation of acids and bases in high concentrations it is important that the monopolar membranes have a very high pH stability and high durability (high pH stability and durability increase the lifetime of the membranes). Also desired is a high efficiency of the process for generating acids and bases. This requires the membranes to have a very high permselectivity to prevent H⁺ and OH⁻ ions to reach the wrong channel causing recombination and hence product loss. Especially for anion exchange membranes it is difficult to obtain a high proton blocking performance at high concentrations due to the small size of protons.

WO 2020/058665 describes porous cationic membranes for detecting, filtering and/or purifying biomolecules.

It is an aim of the present invention to provide anion exchange membranes which are mechanically strong, having a high stability at very low pH values and a high permselectivity at high acid concentrations.

According to a first aspect of the present invention there is provided an anion exchange membrane obtainable by curing a curable composition comprising a component (a) comprising: a compound (A) and/or a compound (B) and/or a compound (C);
wherein:
(A) is an optionally substituted non-aromatic bicyclic structure comprising two nitrogen atoms,
wherein the rings of said non-aromatic bicyclic structure are independently 4-, 5- 6- or 7-membered;
wherein each of said rings comprises a nitrogen atom which may be at a bridgehead position;
wherein to each of said nitrogen atoms are attached one or two groups independently selected from hydrogen, C₁₋₃ alkyl, C₅₋₆ cycloalkyl, and vinylbenzyl, provided that the compound comprises at least two vinylbenzyl groups;
(B) is an optionally substituted 5- 6- or 7-membered non-aromatic heterocyclic ring comprising one nitrogen atom and as substituent to the ring a C₁₋₆alkyl group comprising a nitrogen atom;
wherein to the nitrogen atom of said non-aromatic heterocyclic ring are attached one or two groups independently selected from hydrogen, C₁₋₃ alkyl, C₅₋₆ cycloalkyl, and vinylbenzyl, provided that the compound comprises at least two vinylbenzyl groups;
(C) is an optionally substituted non-aromatic spirocyclic structure comprising two nitrogen atoms,
wherein the rings of said non-aromatic spirocyclic structure are independently 4- 5- or 6-membered;
wherein each of said rings comprises at least one nitrogen atom which may be at a bridgehead position;
wherein to each of said nitrogen atoms are attached one or two groups independently selected from hydrogen, C₁₋₃ alkyl, C₅₋₆ cycloalkyl, and vinylbenzyl, provided that the compound comprises at least two vinylbenzyl groups.

In this document (including its claims), the verb “comprise” and its conjugations is used in its non-limiting sense to mean that items following the word are included, but items not specifically mentioned are not excluded. In addition, reference to an element by the indefinite article “a” or “an” does not exclude the possibility that more than one of the elements is present, unless the context clearly requires that there be one and only one of the elements. The indefinite article “a” or “an” thus usually mean “at least one”. Component (a) of the curable composition may comprise more than one compound selected from compound (A), compound (B) and/or compound (C). Where component (a) is mentioned, this refers to all compounds forming part of component (a). ‘Optionally substituted’ means that the compound comprises optional substituents. A vinylbenzyl group is a CH₂═CHC₆H₄CH₂*-group wherein the asterisk denotes the point of attachment to the other part of the molecule.

The optional substituents in compounds (A), (B) and (C) are preferably C₁₋₃alkyl.

Component (a) of the curable composition has the function of crosslinking agent. Preferably the molar fraction of component (a) in relation to all curable components of the curable composition is at least 0.90.

Preferably at least one of the nitrogen (N) atoms in component (a) is quaternary, more preferably at least two of the nitrogen atoms. When more than one compound is present in component (a), preferably all compounds of component (a) comprise at least one quaternary nitrogen atom, more preferably at least two of the nitrogen atoms are quaternary. The nitrogen atom is non-aromatic, i.e. is not part of an aromatic heterocyclic ring. Preferably the ratio of quaternary N and vinylbenzyl groups is at least 1:3, more preferably at least 1:2, e.g. 1:2 or 2:3. Preferably the ratio of quaternary N and vinylbenzyl groups is at most 2:1, more preferably at most 3:2, e.g. 1:1. In one embodiment component (a) comprises two nitrogen atoms and two vinylbenzyl groups.

The component (a) (i.e. each of the compounds forming part of component (a)) preferably has a molecular weight below 700 Da, more preferably below 600 Da, especially below 550 Da. By keeping the molecular weight of the compound (a) low the ion exchange capacity of the AEM of the present invention is suitable for most applications.

Examples of compounds which may be used as component (a) include the compounds AXL3-1 to AXL3-23 shown below:

| Structure | | Compound |
|---|---|---|
| 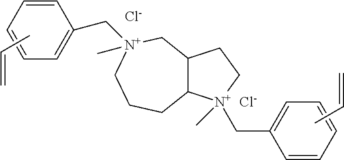 | AXL3-1 | A |
| 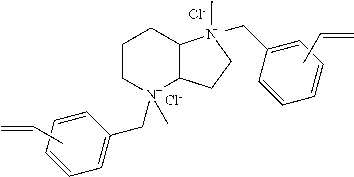 | AXL3-2 | A |
| 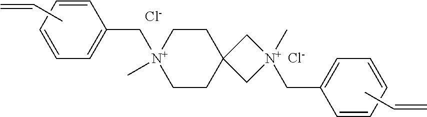 | AXL3-3 | C |
| 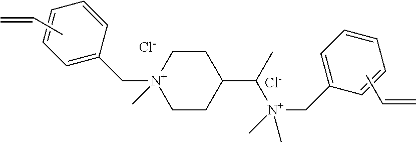 | AXL3-4 | B |
| 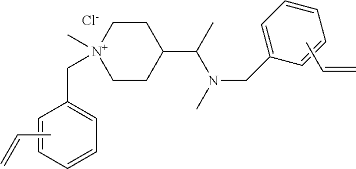 | AXL3-5 | B |
| 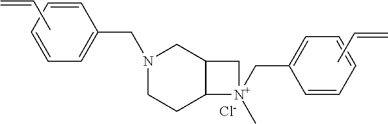 | AXL3-6 | A |
| 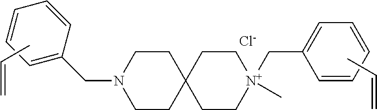 | AXL3-7 | C |
| 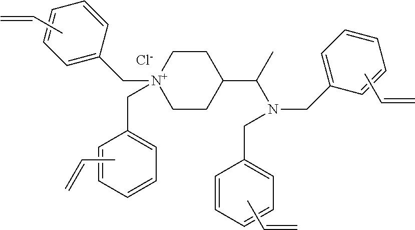 | AXL3-8 | B |
| 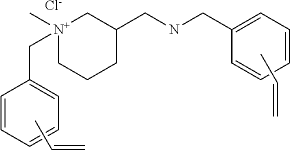 | AXL3-9 | B |
| 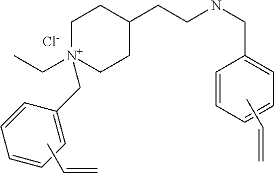 | AXL3-10 | B |
| 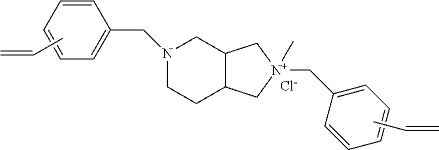 | AXL3-11 | A |
| 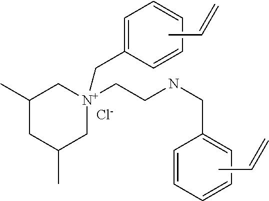 | AXL3-12 | B |
| 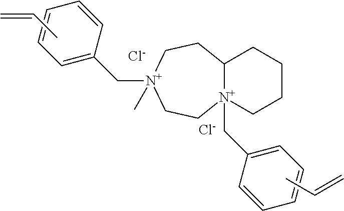 | AXL3-13 | A |
| 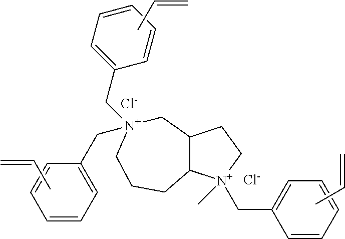 | AXL3-14 | A |
| 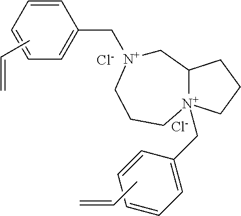 | AXL3-15 | A |
| 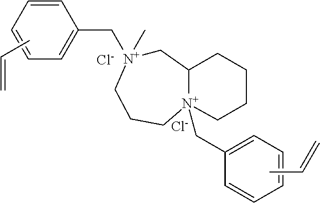 | AXL3-16 | A |
| 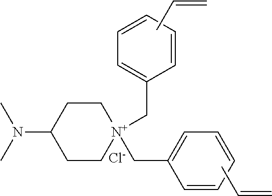 | AXL3-17 | B |
| 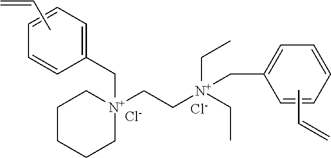 | AXL3-18 | B |
| 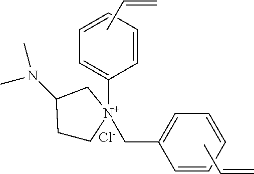 | AXL3-19 | B |
| 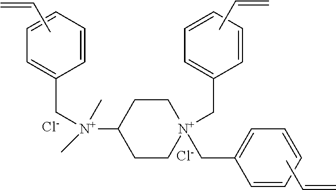 | AXL3-20 | B |
| 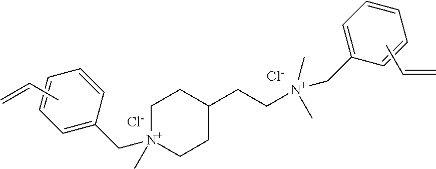 | AXL3-21 | B |
| 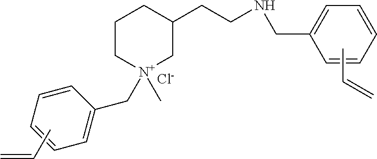 | AXL3-22 | B |
| 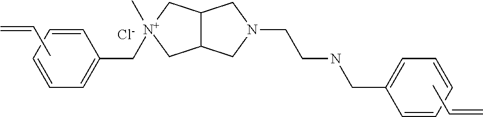 | AXL3-23 | A |

The curable composition preferably comprises 65 to 85 wt % of component (a), more preferably 65 to 75 wt %, in one embodiment 70 to 75 wt %.

In one embodiment the anion exchange membrane according to the first aspect of the present invention comprises at least 1 ppm of component (a) (typically as a result of incomplete curing when the membrane is formed), preferably at least 10 ppm, especially at least 100 ppm. Preferably the anion exchange membrane comprises less than 20,000 ppm of component (a), more preferably less than 10,000 ppm. With component (a) is meant the sum of all compounds forming component (a).

The curable composition optionally further comprises a monomer comprising a cationically charged group and one and only one curable ethylenically unsaturated group as component (b). Preferably the curable composition is free from component (b) or the curable composition comprises a small amount of component (b), e.g. the curable composition preferably comprises 0 to 10 wt % of component (b), more preferably 0 to 7 wt % of component (b).

Component (b) may comprise one or more than one monomer comprising a cationically charged group and one and only one curable ethylenically unsaturated group.

In component (b) the cationically charged group is preferably a quaternary ammonium group. The one and only curable ethylenically unsaturated group present in component (b) is preferably a vinyl or allyl group, more preferably a vinyl group.

In one embodiment component (b) is of Formula (SM) wherein R¹, R² and R³ each independently represents an alkyl group or an aryl group, or 2 or 3 of R¹, R² and R³ together with the positively charged nitrogen atom to which they are attached form an optionally substituted 5- or 6-membered ring; n3 represents an integer of 1 to 3; and X₃^{⊖} represents an anion, preferably chloride, bromide, iodide or hydroxide.

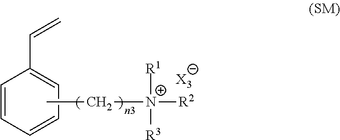

Examples of component (b) of Formula (SM) include the following: compounds.

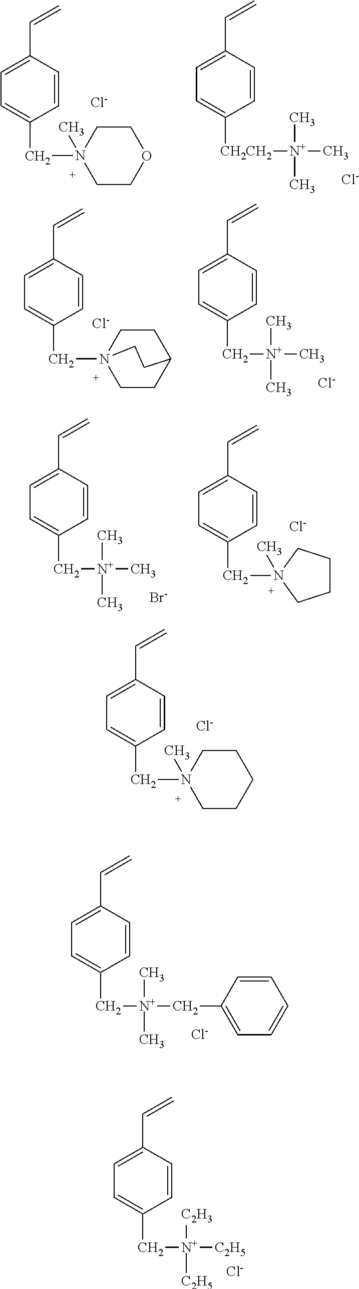

The above components may be prepared as described in, for example, US2016177006.

The curable composition optionally further comprises a radical initiator as component (c). Preferred radical initiators include thermal initiators, photoinitiators and combinations thereof.

The curable composition preferably comprises 0 to 10 wt % of radical initiator, more preferably 0 to 3 wt %. When the curable composition is to be cured using UV light, visible light or thermally the curable composition preferably 0.001 to 2 wt %, especially 0.005 to 1.5 wt %, of radical initiator.

Examples of suitable thermal initiators which may be used as component (c) include 2,2′-azobis(2-methylpropionitrile) (AIBN), 4,4′-azobis(4-cyanovaleric acid), 2,2′-azobis(2,4-dimethyl valeronitrile), 2,2′-azobis(2-methylbutyronitrile), 1,1′-azobis(cyclohexane-1-carbonitrile), 2,2′-azobis(4-methoxy-2,4-dimethyl valeronitrile), dimethyl 2,2′-azobis(2-methylpropionate), 2,2′-azobis[N-(2-propenyl)-2-methylpropionamide, 1-[(1-cyano-1-methylethyl)azo]formamide, 2,2′-azobis(N-butyl-2-methylpropionamide), 2,2′-Azobis(N-cyclohexyl-2-methylpropionamide), 2,2′-Azobis(2-methylpropionamidine) dihydrochloride, 2,2′-azobis[2-(2-imidazolin-2-yl)propane]dihydrochloride, 2,2′-azobis[2-(2-imidazolin-2-yl)propane]disulfate dihydrate, 2,2′-azobis[N-(2-carboxyethyl)-2-methylpropionamidine]hydrate, 2,2′-azobis{2-[1-(2-hydroxyethyl)-2-imidazolin-2-yl]propane}dihydrochloride, 2,2′-azobis[2-(2-imidazolin-2-yl)propane], 2,2′-azobis(1-imino-1-pyrrolidino-2-ethylpropane) dihydrochloride, 2,2′-azobis{2-methyl-N-[1,1-bis(hydroxymethyl)-2-hydroxyethyl]propionamide} and 2,2′-azobis[2-methyl-N-(2-hydroxyethyl) propionamide].

Examples of suitable photoinitiators which may be included in the curable composition as component (c) include aromatic ketones, acylphosphine compounds, aromatic onium salt compounds, organic peroxides, thio compounds, hexa-arylbiimidazole compounds, ketoxime ester compounds, borate compounds, azinium compounds, metallocene compounds, active ester compounds, compounds having a carbon halogen bond, and alkyl amine compounds. Preferred examples of the aromatic ketones, the acylphosphine oxide compound, and the thio-compound include compounds having a benzophenone skeleton or a thioxanthone skeleton described in “RADIATION CURING IN POLYMER SCIENCE AND TECHNOLOGY”, pp. 77-117 (1993). More preferred examples thereof include an alpha-thiobenzophenone compound described in JP1972-6416B (JP-S47-6416B), a benzoin ether compound described in JP1972-3981B (JP-S47-3981B), an alpha-substituted benzoin compound described in JP1972-22326B (JP-S47-22326B), a benzoin derivative described in JP1972-23664B (JP-S47-23664B), an aroylphosphonic acid ester described in JP1982-30704A (JP-S57-30704A), dialkoxybenzophenone described in JP1985-26483B (JP-S60-26483B), benzoin ethers described in JP1985-26403B (JP-S60-26403B) and JP1987-81345A (JPS62-81345A), alpha-amino benzophenones described in JP1989-34242B (JP H01-34242B), U.S. Pat. No. 4,318,791A, and EP0284561A1, p-di(dimethylaminobenzoyl) benzene described in JP1990-211452A (JP-H02- 211452A), a thio substituted aromatic ketone described in JP1986-194062A (JPS61-194062A), an acylphosphine sulfide described in JP1990-9597B (JP-H02- 9597B), an acylphosphine described in JP1990-9596B (JP-H02-9596B), thioxanthones described in JP1988-61950B (JP-S63-61950B), and coumarins described in JP1984-42864B (JP-S59-42864B). In addition, the photoinitiators described in JP2008-105379A and JP2009-114290A are also preferable. In addition, photoinitiators described in pp. 65 to 148 of “Ultraviolet Curing System” written by Kato Kiyomi (published by Research Center Co., Ltd., 1989) may be used.

Especially preferred photoinitiators include Norrish Type II photoinitiators having an absorption maximum at a wavelength longer than 380 nm, when measured in one or more of the following solvents at a temperature of 23° C.: water, ethanol and toluene. Examples include a xanthene, flavin, curcumin, porphyrin, anthraquinone, phenoxazine, camphorquinone, phenazine, acridine, phenothiazine, xanthone, thioxanthone, thioxanthene, acridone, flavone, coumarin, fluorenone, quinoline, quinolone, naphtaquinone, quinolinone, arylmethane, azo, benzophenone, carotenoid, cyanine, phtalocyanine, dipyrrin, squarine, stilbene, styryl, triazine or anthocyanin-derived photoinitiator.

Optionally the curable composition further comprises a monomer free from cationically charged groups, preferably comprising at least two curable ethylenically unsaturated groups, as component (d).

Preferably the curable composition comprises 0 to 5 wt % of component (d). More preferably the curable composition is free from component (d).

The curable composition preferably further comprises solvent as component (e). The solvent is preferably an inert solvent. Inert solvents do not react with any of the other components of the curable composition. In a preferred embodiment component (e) comprises water and optionally an organic solvent, especially where some or all of the organic solvent is water miscible. The water is useful for dissolving components (a) and (b) and possibly also component (c) and the organic solvent is useful for dissolving any organic components present in the curable composition.

Component (e) is useful for reducing the viscosity and/or surface tension of the curable composition. In a preferred embodiment, the curable composition comprises 10 to 40 wt %, preferably 20 to 29 wt %, especially 20 to 26 wt %, of component (e).

Examples of inert solvents which may be used as or in component (e) include water, alcohol-based solvents, ether-based solvents, amide-based solvents, ketone-based solvents, sulphoxide-based solvents, sulphone-based solvents, nitrile-based solvents and organic phosphorus-based solvents. Examples of alcohol-based solvents which may be used as or in component (e) (especially in combination with water) include methanol, ethanol, isopropanol, n-propanol, n-butanol, ethylene glycol, propylene glycol, diethylene glycol, dipropylene glycol and mixtures comprising two or more thereof. In addition, preferred inert, organic solvents which may be used in component (e) include dimethyl sulphoxide, dimethyl imidazolidinone, sulpholane, N-methylpyrrolidone, dimethyl formamide, acetonitrile, acetone, 1,4-dioxane, 1,3-dioxolane, tetramethyl urea, hexamethyl phosphoramide, hexamethyl phosphorotriamide, pyridine, propionitrile, butanone, cyclohexanone, tetrahydrofuran, tetrahydropyran, 2-methyltetrahydrofuran, ethylene glycol diacetate, cyclopentylmethylether, methylethylketone, ethyl acetate, y-butyrolactone and mixtures comprising two or more thereof.

The curable composition may further comprise other components such as inhibitors, wetting agents for improving coating properties, biocides, stabilizers, preferably in low amounts such as between 0 and 3 wt %.

The AEMs preferably have a low water permeance so that (hydrated) ions may pass through the membrane and (free) water molecules do not easily pass through the membrane. Preferably the water permeance of the AEMs is lower than 1·10⁻¹¹ m³/m²·s·kPa, more preferably lower than 5·10⁻¹² m³/m²·s·kPa, especially lower than 4·10⁻¹² m³/m²·s·kPa.

The molar fraction of (all compounds in) component (a) in relation to all curable compounds present in the curable composition is preferably at least 0.91, more preferably at least 0.95. A high ratio of component (a) in relation to all curable compounds present in the curable composition is preferred to obtain a membrane having a high crosslink density and hence a high permselectivity.

The permselectivity (PS) of the membranes of the present invention for protons is preferably at least 50%, more preferably at least 60%, when determined as described below (in a 0.05M-4M HCl system).

The electrical resistance (ER) of the membranes of the present invention is preferably less than 25 ohm/cm², more preferably less than 20 ohm/cm², when component (a) comprises only one quaternary nitrogen atom. The ER of the membranes of the present invention is preferably less than 15 ohm/cm², when component (a) comprises at least two quaternary nitrogen atoms. The ER may be determined as described below (in 2M NaCl).

The molar fraction of component (a) in relation to all curable compounds present in the curable composition is preferably up to 1.0.

The molar fraction of component (a) in relation to all curable compounds present in the curable composition may be calculated by dividing the molar amount of component (a) by the sum of the molar amounts of all curable compounds present in the curable composition. Alternatively, the molar fraction may be determined by measuring the extractables from the anion exchange membrane, e.g. as described on page 19 of WO2022162083.

The distance between the two nitrogen atoms in (the compounds of) component (a) is preferably at least 0.35 nm as this enhances pH stability of the resultant membrane. Preferably the distance between the two nitrogen atoms in component (a) is less than 1.5 nm as this enhances crosslinking density of the resultant membrane. Preferably the nitrogen atoms are cationically charged making the anion exchange membrane suitable for all pH ranges. If the nitrogen atoms in component (a) are not cationically charged the resulting anion exchange membrane can only be used in acidic environments.

Preferably the ion exchange capacity (IEC) of the anion exchange membrane according to the present invention is at least 0.55 meq/g dry membrane, more preferably at least 0.65 meq/g dry membrane when component (a) comprises only one quaternary nitrogen atom. Preferably the IEC of the anion exchange membrane according to the present invention is at least 1.15 meq/g dry membrane, more preferably at least 1.44 meq/g dry membrane when component (a) comprises at least two quaternary nitrogen atoms. Such IECs can provide anion exchange membranes having low electrical resistance. The IEC may be measured by the method described below.

Preferably the IEC of the anion exchange membrane according to the present invention is below 1.85 meq/g dry membrane when measured by the method described below. Such IECs can provide anion exchange membranes which do not swell too much and therefore retain good permselectivity in use.

The anion exchange membrane of the present invention preferably further comprises a porous support.

As examples of porous supports which may be used there may be mentioned woven and non-woven synthetic fabrics and extruded films. Examples include wetlaid and drylaid non-woven material, spunbond and meltblown fabrics and nanofiber webs made from, e.g. polyethylene, polypropylene, polyacrylonitrile, polyvinyl chloride, polyphenylenesulfide, polyester, polyamide, polyaryletherketones such as polyether ether ketone and copolymers thereof. Porous supports may also be porous membranes, e.g. polysulphone, polyethersulphone, polyphenylenesulphone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene and polychlorotrifluoroethylene membranes and derivatives thereof.

The porous support preferably has an average thickness of between 10 and 800 μm, more preferably between 15 and 300 μm, especially between 20 and 150 μm, more especially between 30 and 130 μm, e.g. around 60 μm or around 100 μm.

Preferably the porous support has a porosity of between 30 and 95%, more preferably of 40 to 60%, wherein (in the final membrane) the pores are filled with an anion exchange polymer derived from curing the curable composition, i.e. the membrane preferably comprises 40 to 60 vol % of porous (non-charged) support material and 60 to 40 vol % of anion exchange polymer material (i.e. cured composition according to a first aspect of the present invention). These porosities provide a good balance of low electrical resistance and good permselectivity. The free volume of the porous support, prior to making the membrane, may be calculated from thickness and weight (g/m²) and fiber density (g/m³) data.

The porous support, when present, may be treated to modify its surface energy, e.g. to values above 45 mN/m, preferably above 55 mN/m. Suitable treatments include corona discharge treatment, plasma glow discharge treatment, flame treatment, ultraviolet light irradiation treatment, chemical treatment or the like, e.g. for the purpose of improving the wettability of and the adhesiveness to the porous support to the anion exchange membrane.

Commercially available porous supports are available from a number of sources, e.g. from Freudenberg Filtration Technologies (Novatexx materials), Lydall Performance Materials, Celgard LLC, APorous Inc., SWM (Conwed Plastics, DelStar Technologies), Teijin, Hirose, Mitsubishi Paper Mills Ltd and Sefar AG.

Preferably the porous support is a porous polymeric support. Preferably the porous support is a woven or non-woven synthetic fabric or an extruded film without covalently bound ionic groups.

Preferably the anion exchange membrane of the present invention has an average thickness of between 15 μm and 600 μm, more preferably of between 50 μm and 450 μm and especially between 60 and 240 μm.

According to a second aspect of the present invention there is provided a process for preparing an anion exchange membrane comprising curing a curable composition as defined (and preferred) in relation to the first aspect of the present invention.

The process according to the second aspect of the present invention preferably comprises the steps of:
i. providing a porous support;
ii. impregnating the porous support with the curable composition; and
iii. curing the curable composition;
   wherein the curable composition is as defined above.

The curable composition may be cured by any suitable process, including thermal curing, photocuring, electron beam (EB) irradiation, gamma irradiation, and combinations of the foregoing.

Preferably the process according to the second aspect of the present invention comprises a first curing step and a second curing step (dual curing). Dual curing is preferred since it increases the crosslink density of the resultant anion exchange membrane which in turn improves permselectivity.

In a preferred embodiment of the process according to the second aspect of the present invention the curable composition is cured first by photocuring, e.g. by irradiating the curable composition with ultraviolet (UV) or visible light, or by gamma or electron beam radiation, and thereby causing curable components present in the curable composition to polymerise, and then applying a second curing step. The second curing step preferably comprises thermal curing, gamma irradiation or EB irradiation of the product of the first curing step whereby the second curing step preferably applies a different curing technique to the first curing step. When gamma or electron beam irradiation is used in the first curing step preferably a dose of 60 to 200 kGy, more preferably a dose of 80 to 150 kGy is applied to the curable composition.

In one embodiment the process according to the second aspect of the present invention comprises curing the curable composition in a first curing step to form the anion exchange membrane, winding the anion exchange membrane onto a core (optionally together with an inert polymer foil) and then performing the second curing step on the wound product of the first curing step.

In a preferred embodiment the first and second curing steps are respectively selected from (i) UV curing (first curing step) then thermal curing (second curing step); (ii) UV curing then electron beam curing; and (iii) electron beam curing then thermal curing.

Component (c) may comprise just one radical initiator or more than one radical initiator, e.g. a mixture of several photoinitiators (e.g. for single curing) or a mixture of photoinitiators and thermal initiators (e.g. for dual curing).

In one embodiment the second curing step is performed using gamma or electron beam (EB) irradiation. For the second curing step by gamma or EB irradiation preferably a dose of 60 to 200 kGy is applied to the product of the first curing step, more preferably a dose of 80 to 150 kGy is applied.

For the optional second curing step, thermal curing is preferred. The thermal curing is preferably performed at a temperature between 5° and 100° C., more preferably between 6° and 90° C. The thermal curing is preferably performed for a period between 2 and 72 hours, e.g. around 3 hours for a sheet, between 8 and 16 hours, e.g. about 10 hours for a small roll and between 24 and 72 hours for a large roll. Optionally after the first curing step a polymer foil is applied to the product of the first curing step before winding it onto a spool (this reduces oxygen inhibition, drying out and/or sticking of the product of the first curing step to itself).

In a preferred process according to the second aspect of the present invention, the curable composition is applied continuously to a moving (preferably porous) support, preferably by means of a manufacturing unit comprising a curable composition application station, one or more irradiation source(s) for curing the curable composition, a membrane collecting station and a means for moving the support from the curable composition application station to the irradiation source(s) and to the membrane collecting station.

The curable composition application station may be located at an upstream position relative to the irradiation source(s) and the irradiation source(s) is/are located at an upstream position relative to the membrane collecting station.

Examples of suitable coating techniques for applying the curable composition to a support include slot die coating, slide coating, air knife coating, roller coating, screen-printing, and dipping. Depending on the used technique and the desired end specifications, it might be desirable to remove excess coating from the substrate by, for example, roll-to-roll squeeze, roll-to-blade or blade-to-roll squeeze, blade-to-blade squeeze or removal using coating bars. Curing by light is preferably done for the first curing step, preferably at a wavelength between 300 nm and 800 nm using a dose between 40 and 20000 mJ/cm². In some cases additional drying might be needed for which temperatures between 40° C. and 200° C. could be employed. When gamma or EB curing is used irradiation may take place under low oxygen conditions, e.g. below 200 ppm oxygen.

According to a third aspect of the present invention there is provided use of (a method of using) the anion exchange membrane according to the first aspect of the present invention for use in electromembrane processes, for example for the treatment of polar liquids (e.g. desalination), for the production the acids and bases or for the generation or storage of electricity.

According to a fourth aspect of the present invention there is provided an electrodialysis or reverse electrodialysis device, a bipolar electrodialysis device, an electrodeionization module, a flow through capacitor, a diffusion dialysis apparatus, a membrane distillation module, an electrolyser, a redox flow battery, an acid-base flow battery or a fuel cell, comprising one or more anion exchange membranes according to the first aspect of the present invention.

The invention will now be illustrated by the following, non-limiting examples in which all parts and percentages are by weight unless specified otherwise.

### pH Stability

pH stability of the anion exchange membranes was tested by immersing a sample of the membrane under test in 4M of HCl at 80° C. for at least 1 month. After this treatment, the permselectivity (PS) of the membrane was measured and compared to its PS before the immersion. The pH stability of a membrane was deemed to be “OK” if, after the immersion, the PS was at least 80% the original PS; if lower than 80% of the original PS, the pH stability was deemed to be not good (“NG”).

### Permselectivity (PS)

The permselectivity (PS) (%) (i.e. the selectivity of the anion exchange membranes to the passage of ions of opposite charge) was measured as follows:

The anion exchange membrane to be tested was placed in a two-compartment system. One compartment was filled with a 0.05M solution of HCl and the other with a 4M solution of HCl with the membrane under test separating the two compartments. Settings:
the capillaries as well as the Ag/AgCl reference electrodes (Metrohm type 6.0750.100) contained 3M KCl;
the effective membrane area was 9.62 cm²;
the distance between the capillaries was ca 15 mm;
the measuring temperature was 21.0±0.2° C.;
a Cole Parmer Masterflex console drive (77521-47) with easy load II model 77200-62 gear pumps was used for the two compartments;
Porter Instrument flowmeters (type 150AV-B250-4RVS) and Cole Parmer flowmeters (type G-30217-90) were used to control the flow constant at 500 ml/min;
The anion exchange membrane samples were equilibrated for at least 1 hour in a 0.25M HCl solution prior to measurement. The voltage was read from a regular VOM (multitester) after 20 minutes.
   The PS was calculated from the voltage reading using the Nernst equation. Preferably the PS for HCl was at least 50%.

### Ion Exchange Capacity (IEC)

Prior to measurement, the membranes are brought in the chloride form by immersing the samples in 2 M NaCl solution for 1 hour. The 2 M NaCl solution was refreshed once and the samples were equilibrated for another 24 hours. Subsequently, the membrane samples were rinsed with Milli-Q® water, immersed for 1 hour in fresh Milli-Q® water and rinsed once more with Milli-Q® water.

From the membrane samples with chloride as counter ion 2.0 cm diameter samples were punched out (12.57 cm²), dried for 24 hours at 40° C. and weighed. Then the samples were placed in 75 ml of milli-Q® water for 24 hours, to remove all none-counter ions, followed by rinsing with Milli-Q® water, soaking each sample in 10.00 ml of a 0.1 M AgNO₃ solution, and shaking the solutions with the samples for 24 hours. During the shaking Cl⁻-ions were fully exchanged by NO₃ ions as the Ag⁺-ions removed the Cl⁻-ions by precipitation of AgCl salt. Subsequently, the samples were taken out of the AgNO₃ solutions and rinsed with small portions of Milli-Q® water. The rinsing water of each sample and the corresponding AgNO₃ solution remaining after shaking the membrane sample were combined and titrated with a calibrated 0.1 M KBr solution. and the results were compared with the titration of a blank solution of 10.00 ml of 0.1 M AgNO₃ which had not contained a membrane sample. The difference between titration results of the blank solution and the test solution of each sample was correlated to the ion exchange capacity of the corresponding membranes using Equation (I):

$$IEC ( meq / g dry membrane ) = ( Y - X ) * 0.1 / W \qquad Equation ( I )$$

wherein
Y is the amount of 0.1 M KBr (in ml) used in the titration of the blank AgNO₃ solution;
X is the amount of 0.1 M KBr (in ml) used in the titration of the AgNO₃ solution in which the membrane sample had been soaked combined with the Milli-Q® water used for rinsing the membrane sample after soaking in the AgNO₃ solution; and
W is the dry weight of the membrane (in gram).

### Porosity of the Porous Support

The porosity of the porous support was calculated from thickness and weight (g/m²) and fiber density (g/m³) data as provided by the supplier.

### Electrical Resistance (ER)

ER (ohm·cm²) of the anion exchange membranes prepared in the Examples was measured by the method described by Dlugolecki et al., J. of Membrane Science, 319 (2008) on page 217-218 with the following modifications:
the auxiliary membranes were CMX and AMX from Tokuyama Soda, Japan;
the capillaries as well as the Ag/AgCl references electrodes (Metrohm type 6.0750.100) contained 3M KCl;
the calibration liquid and the liquid in compartment 2, 3, 4 and 5 was 2.0 M NaCl solution at 25° C.;
the effective membrane area was 9.62 cm²;
the distance between the capillaries was 5.0 mm;
the measuring temperature was 25° C.;
a Cole Parmer Masterflex console drive (77521-47) with easy load II model 77200-62 gear pumps was used for all compartments;
the flowrate of each stream was 475 ml/min controlled by Porter Instrument flowmeters (type 150AV-B250-4RVS) and Cole Parmer flowmeters (type G-30217-90); and
the samples of anion exchange membrane were equilibrated for at least 1 hour at room temperature in a 0.5 M solution of NaCl prior to measurement.
The ER is preferably low, e.g. below 15 ohm·cm².
   Determination of the Distance Between the Nitrogen Atoms within Component (a)

The distance between nitrogen atoms in each component (a) was determined by simulation using the open-source Avogadro software version 1.2.0 (see Marcus D Hanwell, Donald 4 Curtis, David C Lonie, Tim Vandermeersch, Eva Zurek and Geoffrey R Hutchison; “AvogadroP An advanced semantic chemical editor, visualization, and analysis platform” Journal of Cheminformatics 2012, 4:17). The structure of each component (a) was drawn in the software and by using the auto-optimization tool the optimal chemical structure was determined. The auto-optimization tool was run with the following settings:
Force field: UFF
Steps per update- 4
Algorithm: Molecular Dynamics (300K)
No atoms were fixed or ignored

When the auto-optimization tool was finished (dE=0), the distance between the nitrogen atoms was determined using the ‘click to measure’ tool.

TABLE 1
Ingredients

| Compound | Supplier |
|---|---|
| 4-OH- | 4-hydroxy-2,2,6,6-tetramethylpiperidin-1-oxyl, |
| TEMPO | a polymerization inhibitor from Sigma-Aldrich |
| TPO-L | 2,4,6-Trimethylbenzoyldi-Phenylphosphinate |
| | from IGM Resins |
| 1173 | 2-Hydroxy-2-methyl propiophenone from BASF |
| V-501 | 4,4′-Azobis(4-cyanovaleric acid), a |
| | radical initiator from FUJIFILM Wako |
| | Pure Chemical Corporation |
| PW | Demineralized water |
| n-propanol | from Sigma-Aldrich |
| CMS-14 | vinylbenzyl chloride, mostly para-isomer |
| | (>90%) from AGC Chemicals |
| Diamine 1 | Decahydropyrrolo[3,2-c]azepine from Merck |
| Diamine 2 | Octahydro-1H-pyrrolo[3,2-b]pyridine from Merck |
| Diamine 3 | 2,7-Diazaspiro[3.5]nonane from Merck |
| Diamine 4 | 1-(1-methyl-4-piperidinyl)ethanamine from Merck |
| Chloroform | From Sigma Aldrich |
| Diethyl ether | From sigma Aldrich |
| Iodomethane | Synthesis grade, from Sigma Aldrich |
| Potassium | Synthesis grade, from sigma Aldrich |
| Carbonate | |

### EXAMPLES EX1 TO EX6 AND COMPARABLE EXAMPLES CEX1 TO CEX3

TABLE 2
Diamines used for the preparation of AXL3-1 to AXL3-5

| Compound | Diamine | Yield |
|---|---|---|
| AXL3-1 | Decahydropyrrolo[3,2-c]azepine | 71% |
| AXL3-2 | Octahydro-1H-pyrrolo[3,2-b]pyridine | 86% |
| AXL3-3 | 2,7-Diazaspiro[3.5]nonane | 64% |
| AXL3-4 | 1-(1-methyl-4-piperidinyl)ethanamine | 78% |
| AXL3-5 | 1-(1-methyl-4-piperidinyl)ethanamine | 77% |

### Procedure for the Preparation of AXL3-1 to AXL3-5

The corresponding diamine (1 mmol) and TEMPO-OH (0.01 mmol) were dissolved in chloroform (100 ml). Potassium carbonate (4 mmol) was suspended in the mixture and iodomethane (2.1 mmol) was added dropwise. The mixture was stirred at room temperature for 3 hours. Water was added to the reaction and the organic layer was separated and subsequently washed with saturated ammonium chloride (2×150 ml). The organic layer was placed in a flask provided with a reflux, 2.05 mmol of CMS-14 was added dropwise. The mixture was gently warmed up to 40° C. and stirred overnight. After completion, the precipitated product was filtered off and the solid was washed three times with diethyl ether. For AXL3-5 2 mmol potassium carbonate and 1.05 mmol iodomethane was used instead of 4 mmol and 2.1 mmol respectively. AXL3-1 to AXL3-5 were obtained as a pale-yellow solid.

CL-1 (used in CEx1) was synthesized as described in US20160177006.

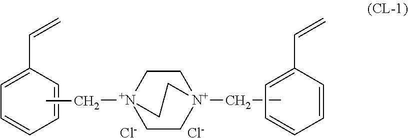

### General Procedure for the Preparation of AXL-A and AXL-B of Comparative Examples CEx.2 and CEx.3

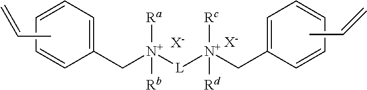

To a 50% solution in ethyl acetate of the corresponding diamine (1 mmol) containing 4-OH-TEMPO (0.1 g), CMS-14 (2.02 mmol) was added dropwise fora 1-hour period. After that the mixture was stirred vigorously for 2 hours. The obtained precipitate was filtered, rinsed with additional ethyl acetate and dried. The diammonium salts were isolated as of white solid. Table 2 below shows the structures of the crosslinking agents so prepared and their yield.

TABLE 3
Structural elements of the crosslinkers of the comparative examples
and the corresponding amines according to Formula (I)

| | | | Diamine (to provide | |
|---|---|---|---|---|
| | R^{a}, R^{b}, | | group L, R^{a}, | |
| Monomer | R^{c} and R^{d} | X | R^{b}, R^{c} and R^{d}) | Yield |
| AXL-A | CH₃—, —, | Cl | N,N′-dimethyl | 86% |
| | CH₃—, — | | piperazine | |
| AXL-B | CH₃—, CH₃—, | Cl | N1,N1,N4,N4- | 69% |
| | CH₃—, CH₃— | | tetramethylbenzene- | |
| | | | 1,4-diamine | |

TABLE 4
Curable compositions and results

| Materials (wt %) | Component | Ex1 | Ex2 | Ex3 | Ex4 | Ex5 | Ex.6 |
|---|---|---|---|---|---|---|---|
| AXL3-1 (compound type A) | (a) | 73.00 | | | | | 25.00 |
| AXL3-2 (compound type A) | (a) | | 73.00 | | | | |
| AXL3-3 (compound type C) | (a) | | | 73.00 | | | 25.00 |
| AXL3-4 (compound type B) | (a) | | | | 73.00 | | |
| AXL3-5 (compound type B) | (a) | | | | | 73.00 | 23.00 |
| TPO-L | (c) | 0.75 | 0.75 | 0.75 | 0.75 | 0.75 | 0.75 |
| 1173 | (c) | 0.75 | 0.75 | 0.75 | 0.75 | 0.75 | 0.75 |
| Wako V-501 | (c) | 0.50 | 0.50 | 0.50 | 0.50 | 0.50 | 0.50 |
| 1-propanol | (e) | 5.50 | 5.50 | 5.50 | 5.50 | 8.50 | 7.00 |
| PW | (e) | 19.48 | 19.48 | 19.48 | 19.48 | 16.48 | 17.98 |

| | | | | | | |
|---|---|---|---|---|---|---|
| 4-OH-TEMPO | 0.02 | 0.02 | 0.02 | 0.02 | 0.02 | 0.02 |
| Total | 100 | 100 | 100 | 100 | 100 | 100 |
| PS (%) | 65.1 | 61.5 | 63.5 | 64.8 | 66.4 | 64.8 |
| ER (ohm · cm²) | 12.6 | 12.1 | 11.3 | 13.2 | 19.4 | 14.9 |
| IEC (meq/g dry membrane) | 1.56 | 1.60 | 1.60 | 1.55 | 0.71 | 1.30 |
| pH stability | good | good | good | good | good | good |
| Distance between N⁺ (nm) | 0.46 | 0.37 | 0.46 | 0.50 | 0.50 | 0.50 |

TABLE 4
Curable compositions and results (continued)

| Materials (wt %) | Component | CEx1 | CEx2 | CEx3 |
|---|---|---|---|---|
| CL-1 | | 73.00 | | |
| AXL-A | | | 73.00 | |
| AXL-B | | | | 73.00 |
| TPO-L | (c) | 0.75 | 0.75 | 0.75 |
| 1173 | (c) | 0.75 | 0.75 | 0.75 |
| Wako V-501 | (c) | 0.50 | 0.50 | 0.50 |
| 1-propanol | (e) | 5.50 | 5.50 | 5.50 |
| PW | (e) | 19.48 | 19.48 | 19.48 |
| 4-OH-TEMPO | | 0.02 | 0.02 | 0.02 |
| Total | | 100 | 100 | 100 |
| PS (%) | | 63.2 | 64.1 | 62.9 |
| ER (ohm · cm²) | | 6.3 | 8.5 | 9.2 |
| IEC (meq/g | | 1.77 | 1.76 | 1.57 |
| dry membrane) | | | | |
| pH stability | | bad | bad | bad |
| Distance between | | 0.26 | 0.30 | 0.57 |
| N⁺ (nm) | | | | |

In CL-1 and AXL-A one respectively two of R^{a} and R^{b} are connected to one respectively two of R^{c} and R^{d} which makes the distance between the two positively charged nitrogen atoms rather small and as a result reducing the pH stability to not acceptable (bad). This is not desired.

AXL-B has an aromatic linking group L and has a low pH stability.

CL-1, AXL-A and AXL-B are crosslinking agents not having the structure claimed for component (a).

### Preparation of the Curable Compositions and the Anion Exchange Membranes

The curable compositions shown in Table 4 above were prepared by mixing sequentially the stated amounts of solids (in wt %) in a mixture of water and n-propanol at a temperature of 40° C. Anion exchange membranes according to the first aspect of the present invention and Comparative Examples were prepared by applying at room temperature (21° C.) each of the curable compositions described in Table 4 onto a porous support (50 g/m² PP/PE porous support of 100 μm thickness, porosity 50%) using a 100 μm Meyer bar, removing the excess using a 4 μm Meyer bar and then curing the composition. UV curing was performed by placing the samples of the supports comprising the curable compositions on a conveyor at 5 m/min equipped with a D bulb in a Light Hammer® 10 of Fusion UV Systems Inc. and exposing the samples to the UV light emitted from the D bulb at 50% power.

The UV cured samples were covered by a 60 μm polyethylene terephthalate (PET) foil (from Toray) without any treatment and were placed into a metallized bag. The bag was vacuumized and sealed. The bag containing the membrane was placed in a regular oven and the membrane was thermally cured for 3 hours at 90° C.

1. An anion exchange membrane obtainable by curing a curable composition comprising a component (a) comprising:
a compound (A) and/or a compound (B) and/or a compound (C);
wherein:
(A) is an optionally substituted non-aromatic bicyclic structure comprising two nitrogen atoms,
wherein the rings of said non-aromatic bicyclic structure are independently 4-, 5-6- or 7-membered;
wherein each of said rings comprises a nitrogen atom which may be at a bridgehead position;
wherein to each of said nitrogen atoms are attached one or two groups independently selected from hydrogen, C₁₋₃ alkyl, C₅₋₆ cycloalkyl, and vinylbenzyl, provided that the compound comprises at least two vinylbenzyl groups;
(B) is an optionally substituted 5- 6- or 7-membered non-aromatic heterocyclic ring comprising one nitrogen atom and as substituent to the ring a C₁₋₆ alkyl group comprising a nitrogen atom;
wherein to the nitrogen atom of said non-aromatic heterocyclic ring are attached one or two groups independently selected from hydrogen, C₁₋₃ alkyl, C₅₋₆ cycloalkyl, and vinylbenzyl, provided that the compound comprises at least two vinylbenzyl groups;
(C) is an optionally substituted non-aromatic spirocyclic structure comprising two nitrogen atoms,
wherein the rings of said non-aromatic spirocyclic structure are independently 4- 5- or 6-membered;
wherein each of said rings comprises at least one nitrogen atom which may be at a bridgehead position;
wherein to each of said nitrogen atoms are attached one or two groups independently selected from hydrogen, C₁₋₃ alkyl, C₅₋₆ cycloalkyl, and vinylbenzyl, provided that the compound comprises at least two vinylbenzyl groups.

2. The anion exchange membrane according to claim 1 wherein component (a) comprises at least one quaternary nitrogen atom.

3. The anion exchange membrane according to claim 1 wherein component (a) comprises at least two quaternary nitrogen atoms.

4. The anion exchange membrane according to claim 1 wherein the distance between the two nitrogen atoms in component (a) is at least 0.35 nm.

5. The anion exchange membrane according to claim 1 wherein the optional substituents are C₁₋₃ alkyl.

6. The anion exchange membrane according to claim 1 wherein component (a) comprises two, three or four vinylbenzyl groups.

7. The anion exchange membrane according to claim 1 which has an ion exchange capacity of at least 0.55 meq/g of dry membrane and lower than 1.85 meq/g of dry membrane.

8. The anion exchange membrane according to claim 1 wherein component (a) has a molecular weight of less than 700 Dalton.

9. The anion exchange membrane according to claim 1 wherein the curable composition further comprises a monomer comprising a cationically charged group and one and only one curable ethylenically unsaturated group as component (b).

10. The anion exchange membrane according to claim 1 wherein the curable composition further comprises a radical initiator as component (c).

11. The anion exchange membrane according to claim 1 wherein the curable composition further comprises a monomer free from cationically charged groups as component (d).

12. The anion exchange membrane according to claim 1 wherein the curable composition further comprises solvent as component (e).

13. The anion exchange membrane according to claim 1 wherein the curable composition comprises: from 65 to 85 wt % of component (a), from 0 to 10 wt % of a monomer comprising a cationically charged group and one and only one curable ethylenically unsaturated group as component (b), from 0 to 10 wt % of a radical initiator as component (c), from 0 to 5 wt % of a monomer free from cationically charged groups as component (d) and from 10 to 40 wt % solvent as component (e).

14. The anion exchange membrane according to claim 1 comprising at least 1 ppm of component (a).

15. A process for preparing an anion exchange membrane which comprises curing a curable composition as defined in claim 1.

16. The process according to claim 15 which comprises the steps of:
(i) providing a curable composition as defined in claim 1;
(ii) applying the curable composition onto a porous support whereby at least a part of the curable composition impregnates the porous support; and
(iii) curing the curable composition.

17. An electrodialysis device, a bipolar electrodialysis device, an electrolyser, a redox flow battery, an acid-base flow battery or a fuel cell comprising one or more anion exchange membranes according to claim 1.

18. A method of using the anion exchange membrane according to claim 1 for the treatment of polar liquids, for the production the acids and bases or for the generation or storage of electricity.
